(19) United States
(12) Patent Application Publication
(10) Pub. No.: US 2008/0317434 A1
(43) Pub. Date: Dec. 25, 2008

(54) INFORMATION RECORDING/REPRODUCING APPARATUS

(75) Inventors: Tomoyuki NONAKA, Chigasaki (JP); Keisuke Inata, Ebina (JP); Mitsuhiro Okada, Sagamihara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/104,484

(22) Filed: Apr. 17, 2008

(30) Foreign Application Priority Data
Jun. 19, 2007 (JP) 2007-161243

(51) Int. Cl. H04N 5/91

(52) U.S. Cl. 386/92; 386/E05.001

(57) ABSTRACT

In increasing multi-channel broadcast situations, user friendliness is insufficient in that digest information can not be generated to satisfy users' demands to record two contents which are broadcast at the same time. In a reproduction apparatus which simultaneously records a plurality of digital video signals and creates a digest of each of the signals to shorten the reproduction time, particular frames of input digital video signals are recorded on a recording medium as reproduction position information. A first decoder decodes the digital video signals as a whole, and a second decoder decodes only digital video signals associated with the reproduction position information. The output of the second decoder is used as a digest generation signal of a digest generation module.

### CLAIM OF PRIORITY

The present application claims priority from Japanese application serial no. JP 2007-161243, filed on Jun. 19, 2007, the content of which is hereby incorporated by reference into this application.

### BACKGROUND

1. Field of the Invention

The present invention relates to a digital signal reproducing apparatus for recording and reproducing digital video signals on and from a recording medium. More particularly, the invention relates to a reproducing apparatus having the function of reproducing only digests from among recorded contents as a whole.

2. Description of the Related Art

Presently, digital broadcasting has become common, and there is a trend toward multi-channel digital broadcasting.

At the same time, the capacity of hard disk drive apparatus (hereinafter referred to as HDDs) for recording programs (contents) or an optical disk has increased to allow an enormous number of contents to be stored. Such a trend has resulted in the spread of digest reproduction which allows a user to view only summaries of recorded contents for efficient viewing of the contents.

By way of illustration of digest reproduction, Patent Document 1 has disclosed an invention which allows a user to set a time zone for digest reproduction easily. Patent Document 2 has disclosed a technique for detecting an important scene from among various pictures in which moving images are time-sequentially processed frame by frame to determine the scene from changes in luminance and color difference signals.

Patent Document 1: JP-A-2004-320092

Patent Document 2: JP-A-2004-295923

### SUMMARY

A result expected from the trend toward multi-channel viewing is situations in which a user wishes to record contents broadcast at the same time. The above cited documents have not disclosed any means for implementing the inventions on a plurality of contents in such situations. Therefore, the inventions are not user-friendly in that digest information can be created for only one content at a time.

A digest reproducing apparatus for digital video signals according to the invention is a reproducing apparatus which simultaneously records a plurality of digital video signals and creates a digest of each of the signals to reduce the reproduction times of the same. The apparatus is characterized in that it includes at least one recording control module which detects particular frames of input digital video signals and records them on a recording medium as reproduction position information, a recording module which records the entire digital video signals on the recording medium, a reproduction control module which reads only digital video signals in periods associated with the reproduction position information on a time-division basis, first and second decoders, and a digest generation module which generates a digest. The first decoder decodes the entire digital video signals, and the second decoder decodes only the digital video signals associated with the reproduction position information. The output of the second decoder constitutes a digest generation signal of the digest generation module.

The invention has been made taking the above-described point into consideration, and it provides a system which can reproduce video signals of digital broadcasts so as to provide digests of two contents broadcast at the same time. Further, since digests of recorded contents can be also reproduced, digest reproduction can performed with improved user friendliness.

### BRIEF DESCRIPTION OF THE DRAWINGS

These and other features, objects, and advantages of the present invention will become more apparent from the following description when taken in conjunction with the accompanying drawings.

FIG. 1 is a block diagram shown for general understanding of digest reproduction;

FIG. 2 shows an example of a program information screen;

FIG. 3 is a block diagram schematically showing a digest reproducing apparatus;

FIG. 4 is a flow chart schematically showing operations involved in digest reproduction;

FIG. 5 is a block diagram showing a configuration of a digest reproducing apparatus of Embodiment 1 of the invention;

FIGS. 6A, 6B, and 6C show MPEG-2 type GOP configurations in Embodiment 1 of the invention;

FIGS. 7A and 7B show a configuration of a TS packet in Embodiment 1 of the invention, and FIG. 7C illustrates a picture layer.

FIGS. 8A and 8B show a configuration of a digest generating stream in Embodiment 1 of the invention;

FIG. 9 schematically illustrates digest reproduction in Embodiment 1 of the invention;

FIG. 10 shows an example of a program information screen in Embodiment 1 of the invention;

FIGS. 11A and 11B are illustrations for explaining data recorded on a recording medium of Embodiment 1 of the invention;

FIGS. 12A, 12B, 12C, and 12D show examples of user interfaces for recorded program information in Embodiment 2 of the invention;

FIGS. 13A and 13B show an example of a user interface for recorded program information in Embodiment 2 of the invention; and

FIG. 14 shows an example of a user interface for recorded program information in Embodiment 3 of the invention.

### DETAILED DESCRIPTION OF PREFERRED EMBODIMENTS

Preferred embodiments of a recording/reproducing apparatus according to the invention will now be described.

### Embodiment 1

### Summary of Digest Reproduction

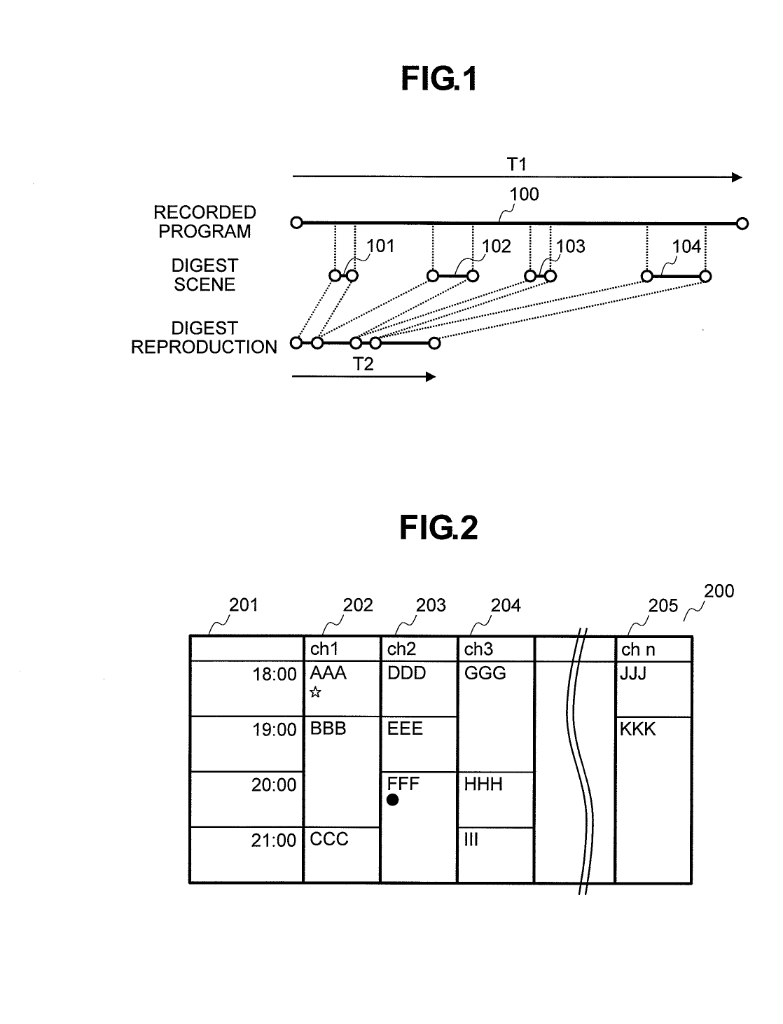

FIG. 1 shows a summary of digest reproduction. Reference numeral 100 represents a stream of recorded contents as a whole. For example, in the case of contents recorded for two hours, T1 represents the two hours. Pieces of digest information 101, 102, 103, and 104 are created from the entire stream, and digest reproduction having a duration T2 of, for example, five minutes can be carried out by reproducing only the periods of the digest information.

FIG. 2 shows an example of a user interface screen for allowing a setting to be made for timed recording. More particularly, the figure represents an example in which a setting for digest reproduction can be made. When display of program information is enabled, time information 201 and pieces of program information 202 to 205 for respective channels are displayed. For example, when a user operates to turn on a digest reproduction function for contents AAA of the program information 202 of the channel 1, an asterisk symbol is displayed to indicate that the contents have been registered. A dot-like symbol is displayed for contents which have only been recorded and for which the digest reproduction function is off.

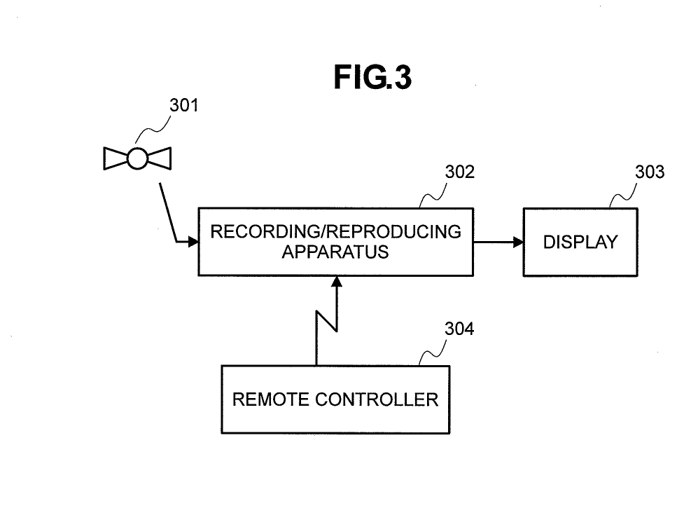

FIG. 3 schematically shows a recorder having a digest reproduction function. Contents of digital broadcasts are received by an antenna 301 and recorded and reproduced by a recording/reproducing apparatus 302, and reproduced contents are output to a display apparatus 303 such as a flat panel display. User operations are primarily made using a remote controller 304.

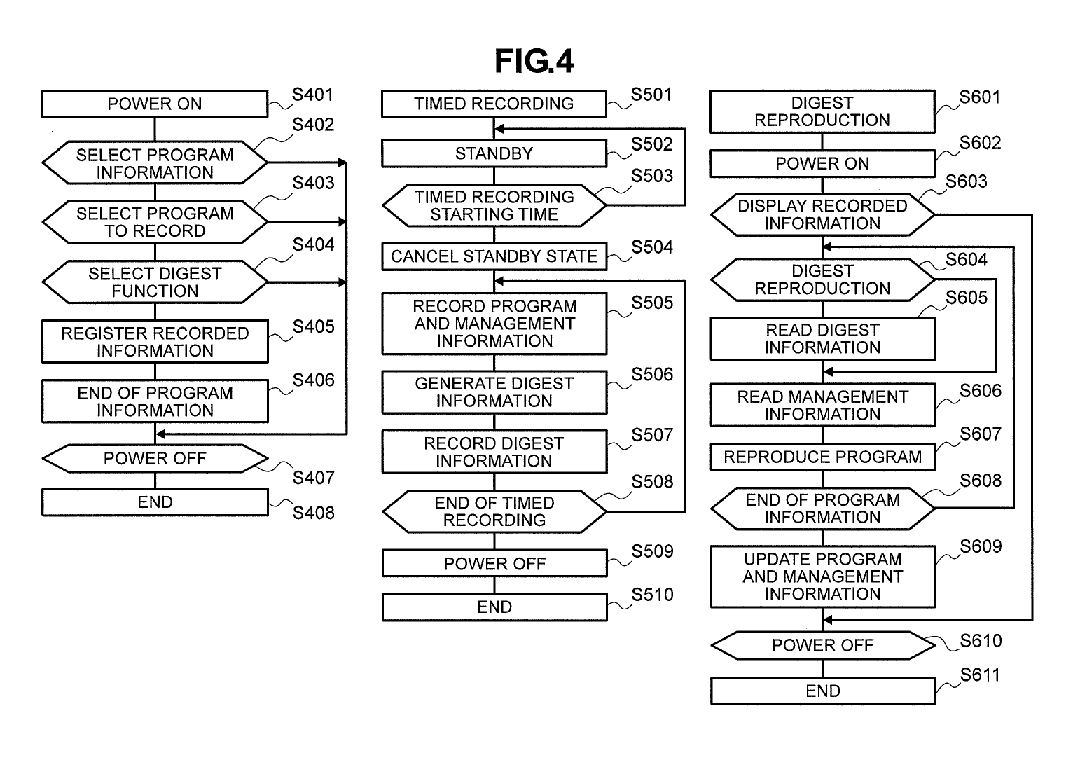

FIG. 4 is a flow chart schematically showing operations involved in digest reproduction. The steps from power-on up to setting of contents recording are represented by S401 to S408. The steps from starting of timed recording up to the end of the timed recording are represented by S501 to S510. The steps from starting of digest recording up to the end of the digest recording are represented by S601 to S611.

At the beginning of the operations, the power supply of the recording/reproducing apparatus 302 is turned on (S401), and display of program information is chosen using the remote controller 304 (S402). Program information as shown in FIG. 2 is displayed on the display apparatus 303. Then, contents to be recorded are selected (S403), and the user is prompted for selection of the digest reproduction function (S404) When a setting for recording is made, information on the contents is registered as management information (S405). The display of program information is then terminated (S406), and the power supply is tuned off (S407). If no selection is made as to setting for recording when the program information is displayed, the apparatus waits for the user to turn off the power supply (S407). The recording setting operation is terminated when the power supply is turned off (S408).

Then, the apparatus proceeds to operations for timed recording 501. The apparatus stays in a standby state until a time set for timed recording comes (S502). When the set time comes (S503), the standby mode is canceled (S504), and relevant contents and management information is recorded (S505).

At the same time, digest information is generated (S506) and similarly recorded on a recording medium (S507). The recording is continued until the timed recording end time comes (S508). The recording is terminated when the end of the program for timed recording comes, and the power supply is turned off (S509).

When digest reproduction is to be performed (S601), the power supply is turned on again (S602), and display of recording information is chosen using the remote controller 304 (S603). When a digest of the contents is reproduced according to the setting for digest reproduction (S604), the digest information is read (S605), and the data of an address indicated by the relevant management information is read (S606). Thus, the reproduction of the contents is stared (S607), and the reproduction continues until the end of the contents (S608) When no setting for digest reproduction has been made, the apparatus enters a normal reproduction mode.

The result of the digest reproduction has the duration T2 shown in FIG. 1, and the full reproduction as the duration T1. When the digest reproduction is terminated, the symbol is updated to indicate that the digest has already been viewed (S609). The power supply is then turned off (S610) to terminate the process (S611). The digest function is implemented in such a mode.

### Schematic Configuration for Digest Reproduction

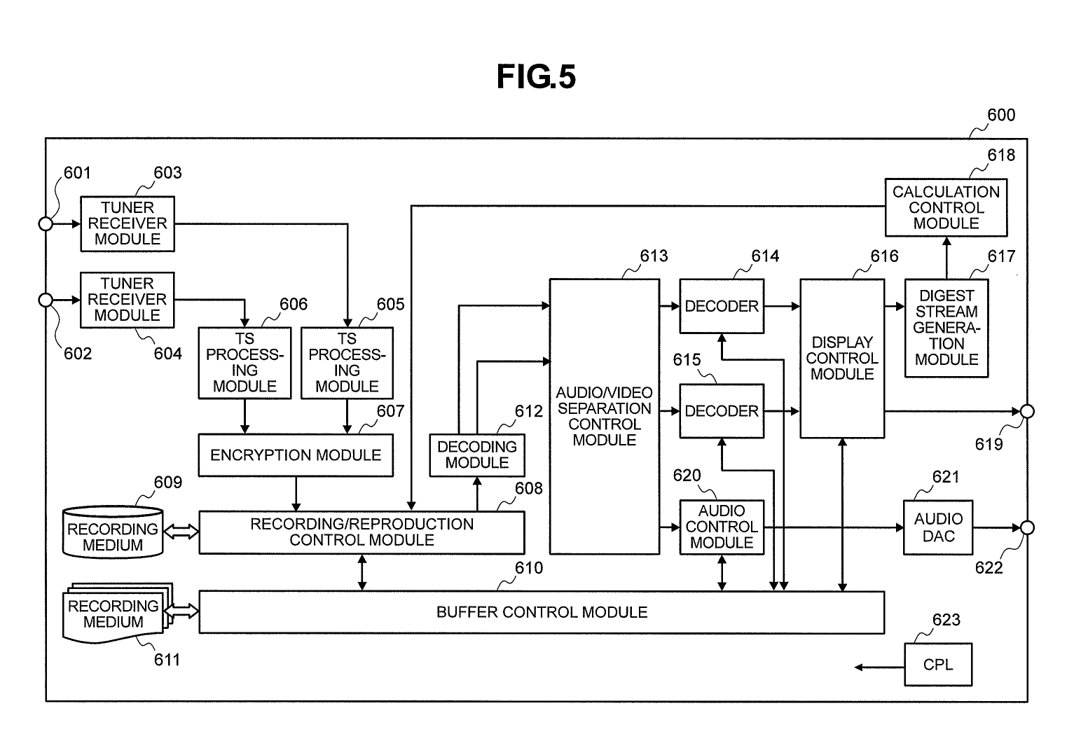

FIG. 5 is a block diagram showing an example of a schematic configuration for implementing digest reproduction. In FIG. 5, reference numerals 601 and 60 represent input terminals for receiving electric waves from repeater stations for ground wave digital broadcasts or broadcast satellites. The input electronic waves in an RF band are frequency-converted by tuner receiver modules 603 and 604 into signals in an IF (intermediate frequency) band. Thus, the signals are demodulated into signals in a certain band independent of the channels over which they are received and are thereafter demodulated to be transmitted in the form of a bit stream.

Digital errors generated during the transmission are detected and corrected, and the stream is thereafter digitally compressed at a high efficiency using, for example, the MPEG (Moving Picture Experts Group) standard. Transmission encryption of the stream is canceled, and one transponder frequency at which programs are multiplexed is selected. A bit stream in the selected transponder is separated into audio and video packets of one program. The packets are supplied to stream processing modules 605 and 606.

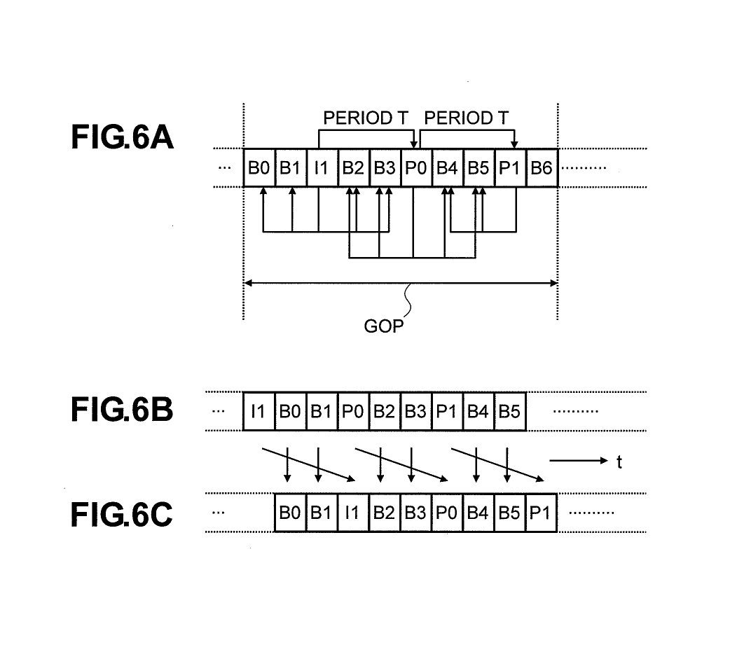

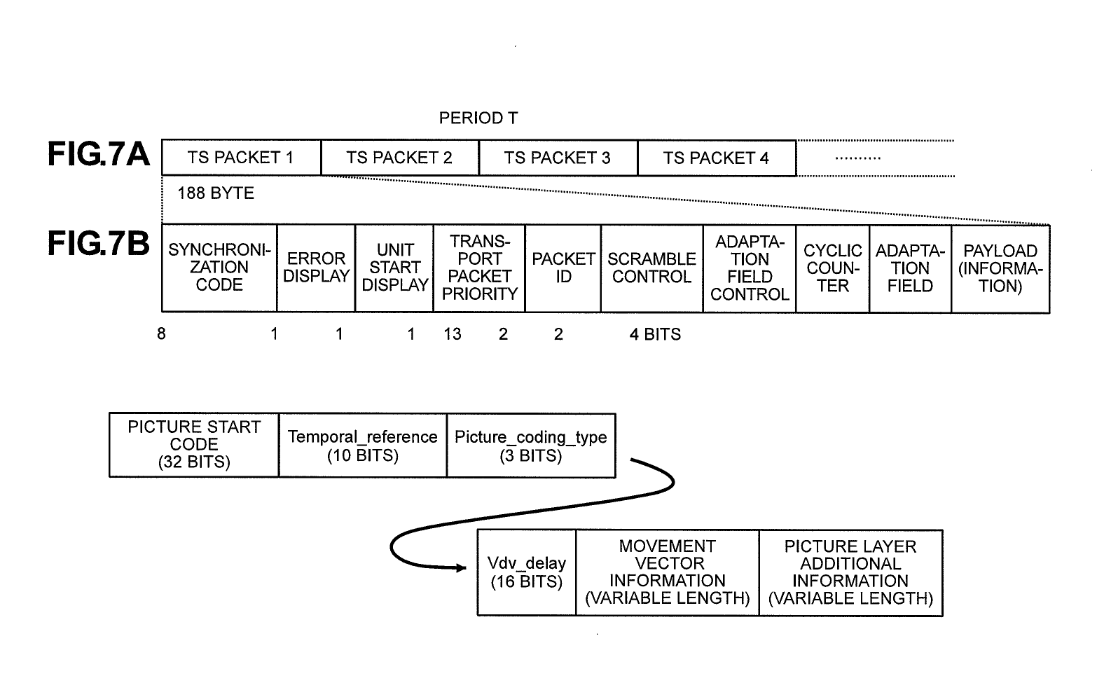

Examples of streams supplied to the stream processing modules 605 and 606 are shown in FIGS. 6A, 6B, 6C, 7A, and 7B. The digital signals are supplied in the form of a stream called a transport stream (hereinafter referred to as TS) obtained by connecting a plurality of PES (Packetized Elementary Stream) packets, each PES packet being formed by elementary streams having a common time base which are image/audio data streams encoded according to the MPEG-2 method.

When image data encoded according to MPEG-2 are reproduced, a single image does not constitute a complete piece of information because the image is created based on data of images preceding and following the same. Therefore, a GOP (Group of Pictures) constituted by data of several images is used as a unit which can be randomly accessed.

FIG. 6A shows an arrangement of images in a GOP according to the MPEG-2 method, and FIG. 6B shows the order in which the images are displayed when they are decoded according to the MPEG-2 method. As shown in FIG. 6A, a GOP includes at least one I picture (intra-picture encoded image). An I picture is obtained by encoding I picture image data using DCT (Discrete Cosine Transform) and quantization.

An I picture is an image which is encoded only from the information of itself and which is generated without using inter-picture prediction. An image coming at every predetermined period after the I picture is converted into a P picture (inter-picture prediction-encoded image) using inter-picture prediction encoding in the forward direction.

The I picture and the P pictures are encoded in the same order as that of the original images. Each piece of image data between an I picture and a P picture is converted into a B picture (bidirectional prediction-encoded image) using bidirectional prediction encoding based on the image data preceding and following the same (the I picture and the P picture).

The B picture is encoded after the I picture and the P picture are encoded. A PES packet data including digital data encoded according to the MPEG-2 method are recorded on a recording medium in a configuration as described above.

Referring to the decoding of the image data, as shown in FIG. 6B, the I picture which has been encoded only from intra-picture data is first decoded. Then, the P pictures which have been encoded using forward inter-picture prediction are decoded. Finally, the B pictures which have been encoded using bidirectional prediction are decoded.

As shown in FIG. 6C, reproduction images B0, B1, I1, B2, B3, P0, B4, B5, P1, and so on are reproduced in the order listed as time t passes. The recording/reproducing apparatus having such a configuration is capable of special modes of reproduction such as double speed reproduction, reverse reproduction, and timed search which are made possible by reproducing only I pictures that are intra-frame-encoded. An I picture can be also used as a signal for generating digest information.

FIGS. 7A and 7B show a configuration of MPEG-2 TS packets. A TS packet 1 shown in FIG. 7A includes a synchronization code, a packet ID, payload (information), and etc. as shown in FIG. 7B. The payload (information) in FIG. 7B includes information such as a picture start code and a picture code type (three bits). The presence of an I picture in an incoming packet can be detected by detecting a packet code ID or picture code type in the packet. The stream processing modules 605 and 606 have the functions of detecting an I picture and adding a time stamp to the same.

An encryption module 607 has the function of encrypting streams supplied from the stream processing modules 606 and 607 to protect the copyright of the contents. The encrypted streams are intermittently recorded on a second recording medium 609 through a recording/reproduction control module 608, a buffer control module 610, and a first recording medium 611.

Streams constituted by only I picture frames among the simultaneously recorded streams detected by the stream processing modules 605 and 606 are read from the second recording medium 609. Further, the entire streams are read to allow any of the simultaneously streams to be viewed.

Those streams are decrypted by a decoding module 612 to be supplied to a video/audio separation module 613 as two types of streams, i.e., full streams and streams for generating digest information. A stream for generating digest information constituted only by I pictures supplied from the video/audio separation module 613 is decoded by a first decoder 614 into a video signal, re-packetized by the display control module 616, and supplied to a digest stream generation module 617.

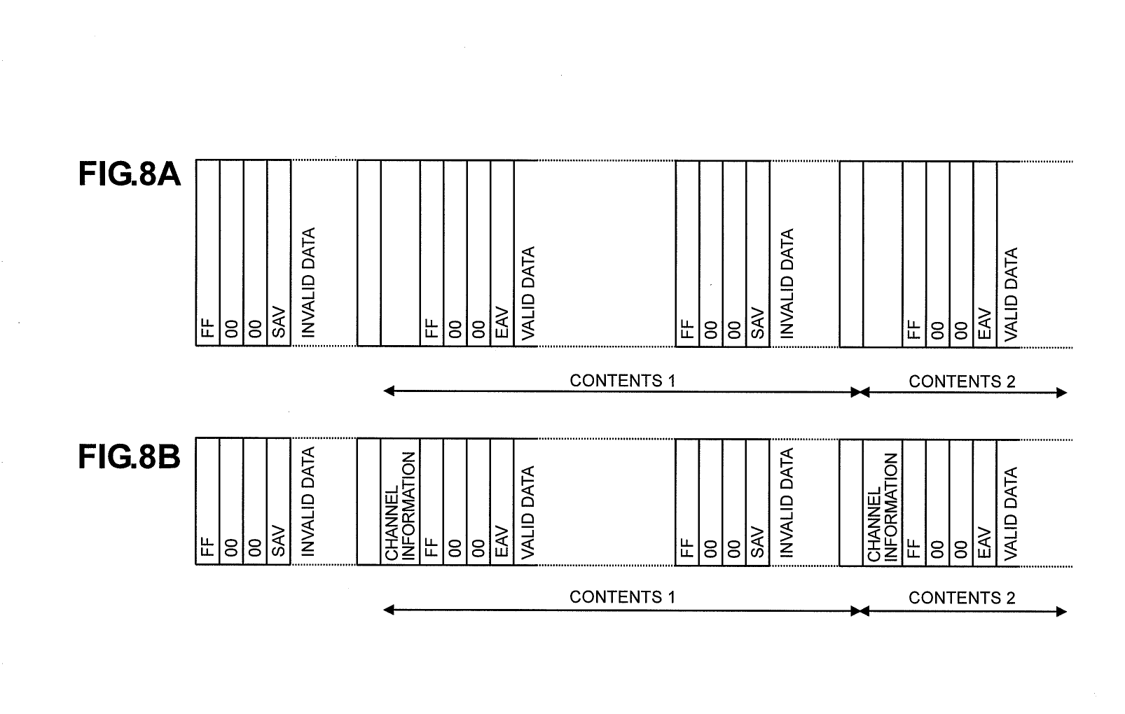

FIG. 8A shows an example of the re-packetized video signal which is in the Rec. 656 format. FIG. 8B shows an example in which channel information is inserted in invalid information periods of the Rec. 656 format.

The digest stream generation module 617 supplies the video signal to a calculation control module 618 after assigning a number unique to each contents title in the invalid period thereof. The calculation control module is constituted by, for example, a digital signal processor, and the module calculates characteristic data from a video signal supplied thereto to generate digest information. The digest information thus generated is recorded in the second recording medium 609 by the recording/reproduction control module 608.

The video/audio separation module 613 separates the entire streams to be viewed into video and audio streams and thereafter supplies the video streams to a second decoder 615. The decoder decompresses the streams into video signals which are then sent through the display control module 616 to an output terminal 619 to be output to an external monitor. The audio streams are decoded by an audio control module 620 and are thereafter sent through a digital/analog converter 621 to an output terminal 622 to be connected to an external apparatus such as a speaker. Reference numeral 623 represents a CPU which controls the recording/reproducing apparatus 600 as a whole.

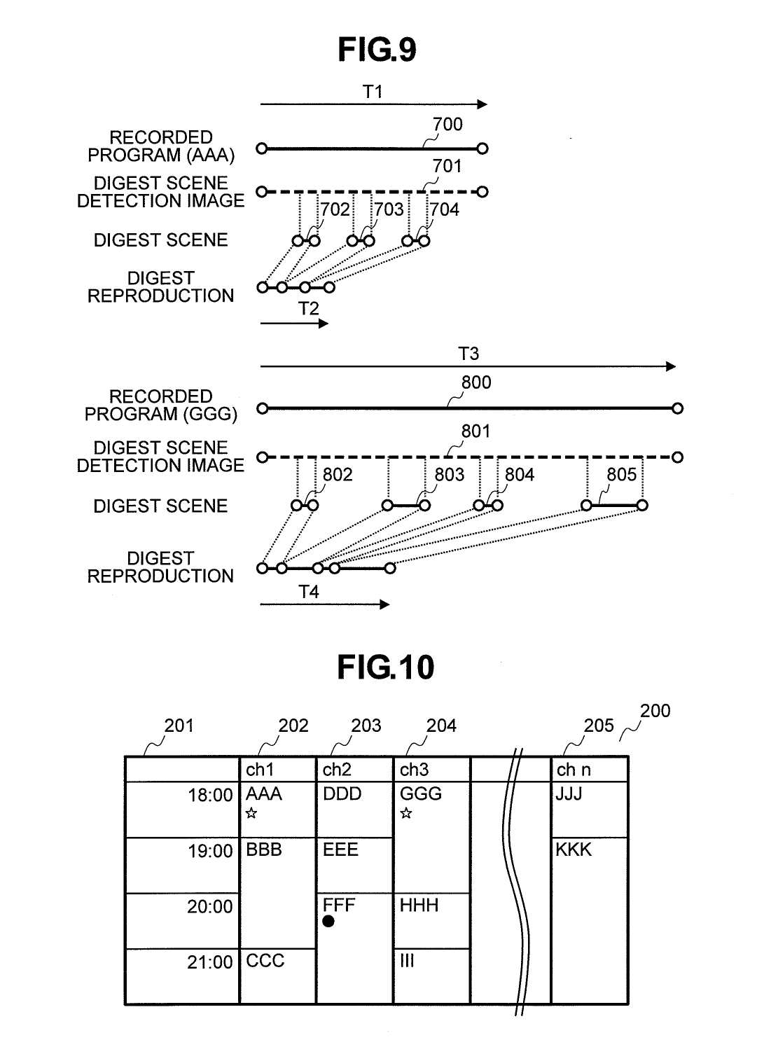

FIG. 9 shows an example of a user setting screen on which a setting is made to record different contents in the same time zone and to activate the digest reproduction function for both of the contents. In the example, contents AAA of a channel 1 and contents GGG of a channel 3 overlap each other for one hour since they start at time 18:00. At this time, for example, the contents AAA are processed in a path starting at the tuner receiver module 603, and the contents GGG are processed in a path starting at the tuner receiver module 606.

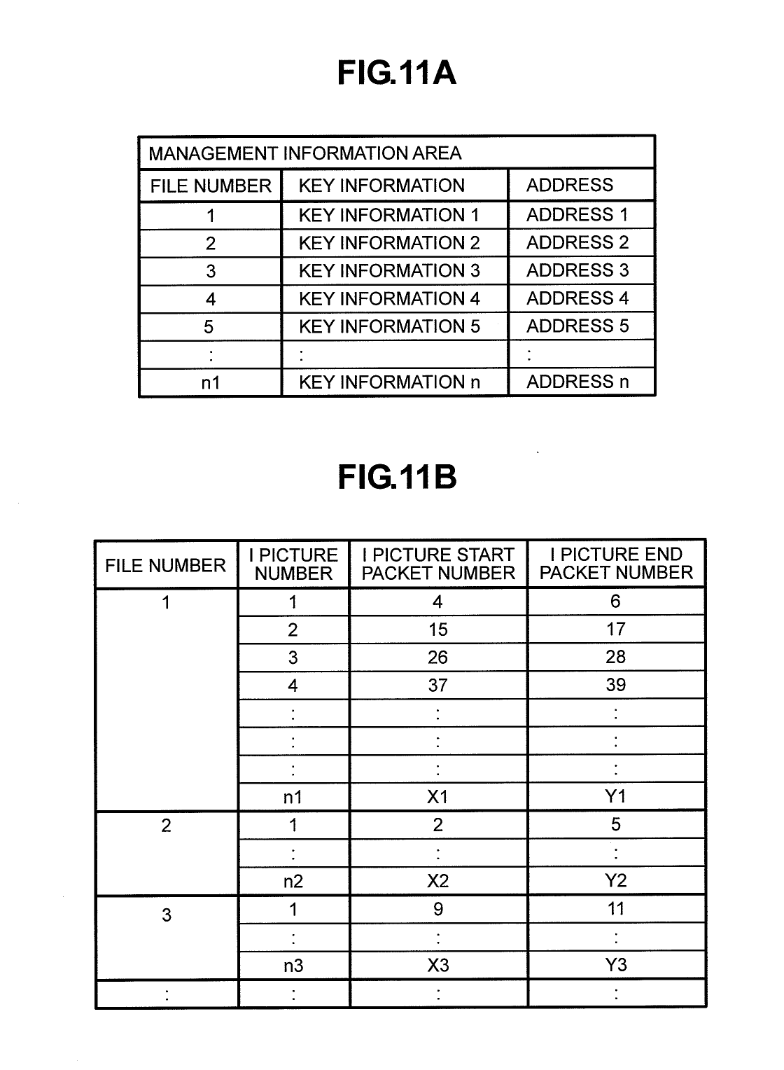

FIG. 11A shows management information associated with recording of contents on the second recording medium, and FIG. 11B shows an example of an I picture detection table. For example, when the contents AAA correspond to a file No. 1, and the contents GGG correspond to a fine No. 2.

Streams 700 and 800 for generating digests are obtained by reading I pictures in the file No. 1 and the file No. 2 alternately from the beginning of the files, which makes it easier to allocate the streams to respective channels at the digest stream generation module 617.

Reference numerals 702, 703, 704, 802, 803, 804, and 805 represent digest scenes generated by the calculation control module 618. Thus, addresses for reproduction are decided for both contents, and digests for the contents can be reproduced.

### Embodiment 2

### (Generating Digest Information in Vacant Time)

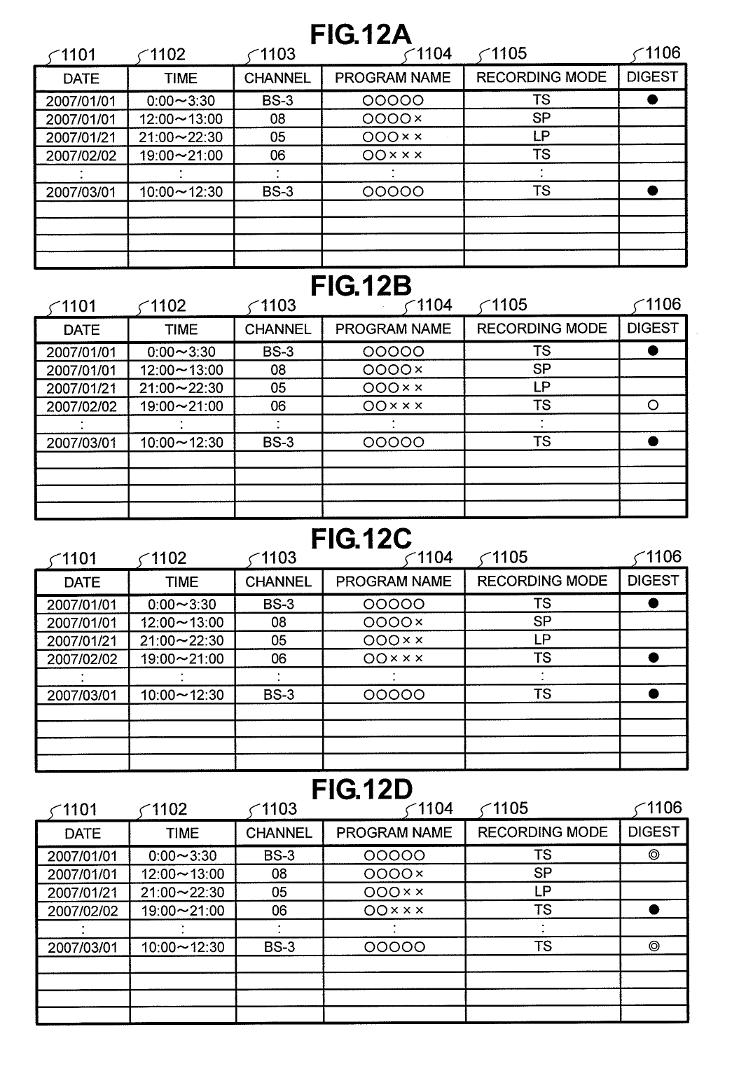

FIGS. 12A, 12B, 12C, and 12D are tables showing an embodiment in which a time zone for digest reproduction can be arbitrarily set. The tables have columns showing information associated with recording such as date information 1101, time information 1102, channel information 1103, and program name information 1104, a recording mode column 1105, and a digest column 1106.

The spaces without dot in the digest column 1106 of FIG. 12A represent contents for which no digest setting has been made at the time of recording. FIG. 12B shows an example in which setting is changed to allow a digest to be reproduced for contents named “00xxx”. A user may select the digest column 1106 using the remote controller to put a mark, e.g., a white circle, to indicate contents for which setting has been changed to enable digest reproduction.

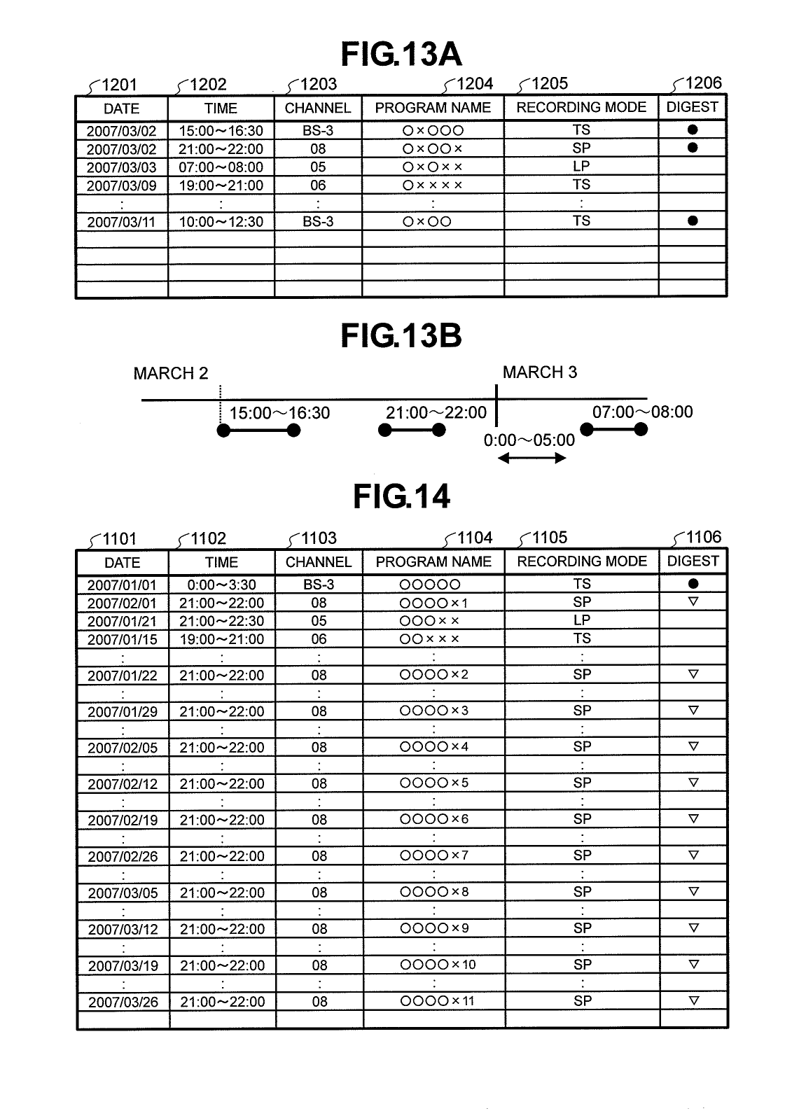

FIGS. 13A and 13B show an example in which digest information is generated for contents marked in such a manner using a time zone for which no setting is made for timed recording. Time zones for which no setting is made for timed recording are displayed, and a user may select any of the vacant time slots to make a setting for enabling digest reproduction in the time slot which is 0:00 to 5:00 on March 3 in the illustrated example.

When digest information is generated, the digest column of the user interface screen is changed to show a dot as shown in FIG. 12C, and such a mark is further changed to a double circle when the contents associated therewith have already been viewed. Thus, contents which have already been viewed can be easily recognized.

### Embodiment 3

### (Generation of a Digest for a Plurality of Contents)

FIG. 14 shows an embodiment in which one digest can be generated for contents such as a serial drama or sport tournament. A user marks contents of interest with inverted triangle symbols in a digest column 1106 in the table. Digest information is generated for the contents marked with the inverted triangle symbols in the order of dates and times when the contents are recorded.

I picture information can be read in groups each corresponding to a set of contents, which makes it possible to view digest reproduction of the first through eleventh episodes of a drama easily. Thus, a reproducing apparatus having improved user-friendliness can be provided.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A digest reproducing apparatus for digital video signals which simultaneously records a plurality of digital video signals and creates a digest of each of the signals to reduce the reproduction times of the same, the apparatus comprising:
at least one recording control module which detects particular frames of input digital video signal and records them on a recording medium as reproduction position information;
a recording module which records the entire digital video signals on the recording medium;
a reproduction control module which reads only digital video signals in periods associated with the reproduction position information on a time-division basis;
first and second decoders; and
a digest generation module which generates a digest, wherein:
the first decoder decodes the entire digital video signals;
the second decoder decodes only the digital video signals associated with the reproduction position information; and
the output of the second decoder constitutes a digest generation signal of the digest generation module.

2. A digest reproducing apparatus for digital video signals according to claim 1, which reads digital video signals of different contents in each frame when reading plural pieces of the reproduction position information.

3. A digest reproducing apparatus for digital video signals according to claim 1, wherein the generation of a digest is set at any time other than a time which has already been set.

4. A digest reproducing apparatus for digital video signals according to claim 1, which sequentially reads plural pieces of the reproduction position information for each content to generate a digest as one content.

5. A digest reproducing apparatus for digital video signals according to claim 1, wherein the plurality of digital video signals are broadcast signals and wherein the particular frame is an I picture included in an MPEG-2 transport stream.
